(19) United States
(12) Patent Application Publication
(10) Pub. No.: US 2003/0236746 A1
(43) Pub. Date: Dec. 25, 2003

(54) Check and cash dispensing machine and method

(76) Inventors: Michael B. Turner, Hurst, TX (US); Dyron L. Clower, Dallas, TX (US); Jay B. Shipowitz, Southlake, TX (US)

Correspondence Address: Edward Jorgenson, Philip G. Meyers Intellectual Property Law, P.C., Snite 302, 1009 Long Prairie Road, Flower Mound, TX, 75022, US

(21) Appl. No.: 10/175,584

(22) Filed: Jun. 19, 2002

(51) Int. Cl. G06F 17/60

(52) U.S. Cl. 705/40

(57) ABSTRACT

A method for making a payment includes the steps of determining a payment amount due from a payor to a payee, identifying the payee when the payee enters identifying information at an automated payment station, verifying an amount of a payment due to the payee, and receiving at the payment station an election by the payee to receive a check or cash as the payment. If the payee selects a check, a check is printed for the payee at the payment station, whereas if the payee selects cash, cash is dispensed to the payee at the payment station. The payment station may be a kiosk similar in appearance to an ATM machine, but with the capability to both print checks and dispense cash in response to a user election.

### TECHNICAL FIELD

The invention relates to check and cash dispensing machines, a system for automated check printing and cash dispensing and a method thereof

### BACKGROUND OF THE INVENTION

Debit card and automated teller machine (ATM) systems are well known and widely used in the banking and financial industry. Likewise, direct deposit systems are well known and widely used for electronic funds payroll transfers from, for example, an employer to an employee's bank account. A direct deposit system used in conjunction with an ATM/debit card enables a customer to receive funds via electronic transfer to his/her account, withdraw funds in the form of cash from an ATM and/or use the card to purchase goods from vendors that accept the card.

This system is, however, not without drawbacks. The customer is required to maintain an account with a financial institution that accepts direct deposits and provides ATM services. The customer is also required to obtain and carry a card with his/her account information magnetically encoded on the card in order to utilize the ATM system. Withdrawals from an ATM machine are typically limited to fixed amount per day, typically no more than several hundred dollars. Cash withdrawals from ATM machines are also normally limited to multiples often or twenty dollars insofar as such machines are not equipped to dispense one or five dollar bills. ATM machines are also not equipped to print checks, a form of funds transfer that many customers may believe to be safer and more convenient than receiving cash.

The apparatus, system and method described herein overcomes these shortcomings by providing the customer the option of receiving funds in the form of either checks or cash. The system and method of the invention also allows a customer to access the full amount of funds available at the time and enables the customer to receive a cash disbursement in an amount other than a multiple of five, ten or twenty dollars.

### SUMMARY OF THE INVENTION

A method for making a payment according to the invention includes the steps of determining a payment amount due from a payor to a payee, identifying the payee when the payee enters identifying information at an automated payment station, verifying an amount of a payment due to the payee, and receiving at the payment station an election by the payee to receive a check or cash as the payment. If the payee selects a check, a check is printed for the payee at the payment station, whereas if the payee selects cash, cash is dispensed to the payee at the payment station. The payment station according to the invention may be a kiosk similar in appearance to an ATM machine, but with the capability to both print checks and dispense cash in response to a user election.

In one common use of the method of the invention, the payor is an employer and the payee is an employee of the payor due to receive wages. According to a preferred form of the invention, a payee is first enrolled to receive payment and receives identifying information such as a PIN number, or is instructed by the payor to use his or her social security or other existing number as identification for purposes of receiving payment. A payment processing center receives an electronic pay file from the payor at a payment processing center remote from the payment station, including information identifying the payee and an amount due to be paid to the payee. At the time the payee appears at the payment station to collect payment, the station transmits information concerning the payee to the processing center and receives back a verification of an amount due the payee from the processing center. The processing center may charge a fee if the payee elects to receive cash. Such fee preferably is calculated to include any amount less then smallest unit of currency the payment station is able to dispense, such as one dollar.

The invention further provides an automated payment station suitable for use in the foregoing method. Such a station includes a computer programmed to dispense cash and print checks according to program logic, a check printer which prints checks in response to signals from the computer, a cash dispenser which dispenses cash in response to signals from the computer, a display device connected to the computer and positioned to display messages to a user, a data entry device which permits entry of data and selection of options by the user, and a cabinet enclosing the computer, check printer, cash dispenser, display device and data entry device, which cabinet has suitable access openings therein to permit the machine to dispense cash and checks from the cash dispenser and check printer, respectively. A signature capture pad may be mounted on the outside of the cabinet and connected to transmit an image of a signature to the computer for verification purposes. A magnetic card reader may be provided that is accessible through a slot in the cabinet and connected to the computer as another way to verify the identity of the cardholder-payee.

In a preferred form of the invention, the program logic used by the computer offers a user a choice of receiving a check or cash, and actuates the check printer or cash dispenser in response to an election made by the user with the data entry device. A touch screen conveniently acts as both the display device and data entry device. A communications link and suitable software may be provided for connecting the computer for electronic communication with a remote processing center that verifies the user's identity in response to queries send by the computer and transmits to the computer a payment amount due to the user. The cash dispenser preferably includes at least three cassettes containing currency in different denominations, with at least one cassette containing a lowest common denominator currency, such as one dollar bills.

The invention further provides a system for making payments at a number of locations, which system includes a number of automated payment stations as described above which communicate with a common processing center. These and other aspects of the invention are discussed in the detailed description that follows.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a perspective view of a kiosk or cash and check dispensing machine according to the invention;

FIG. 2 is a block diagram further illustrating components of the kiosk of FIG. 1;

FIG. 3 is a front view of an alternative kiosk or cash and check dispensing machine according to the invention, in a closed condition;

FIG. 4 is a front view of the kiosk of FIG. 3 in an open condition;

FIG. 5 is a block diagram illustrating the use of a system and method according to the invention; and

FIG. 6 is a flow chart of a transaction using the apparatus, system and method of the invention.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention and do not delimit the scope of the invention.

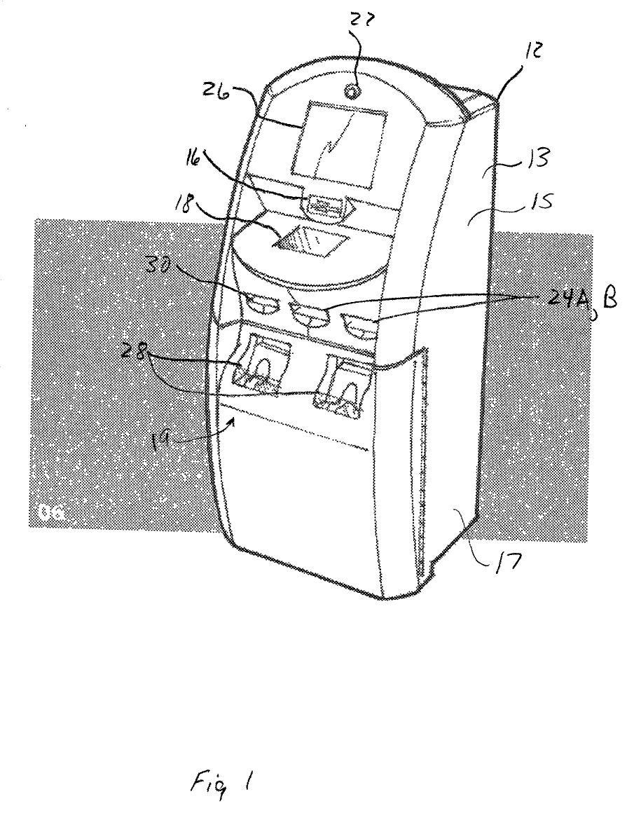

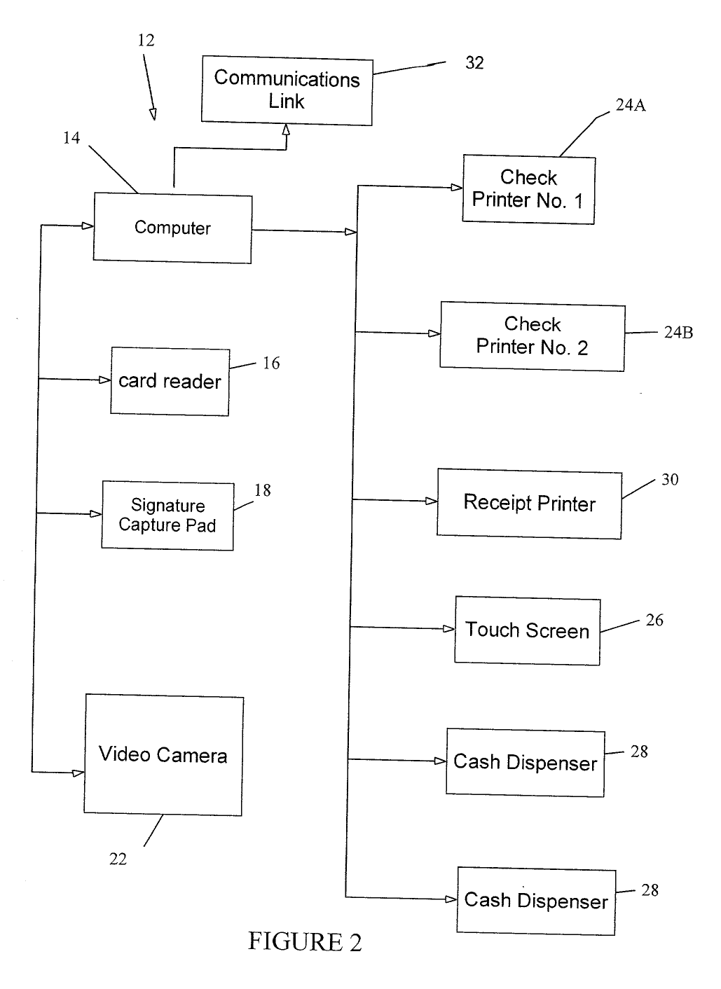

Referring to FIGS. 1-2, a cash and check dispensing station or kiosk 12 according to the invention includes a plastic cabinet 13 that holds a computer 14 and various computer-controlled input and output devices. Cabinet 14 is made of roto-molded polyethylene plastic for durability and vandal resistance. An upper section 15 of cabinet 14 houses three thermal printers (24A, 24B, 30), the control unit (PC 14), a card reader 16, a video camera 22 for recording an image of consumers using kiosk 12, and a touch screen 26 to allow customers to enter relevant information and instructions as described in detail below. A signature capture pad 18 is attached to the outside of the upper section. A lower section 17 of cabinet 14 acts as the base for the upper unit and encloses a cash dispenser/vault mechanism 19.

Kiosk 12 contains two Source Technologies MT-2K Thermal Transfer MICR check printers 24A, 24B. Each printer is configured to print 400 8.5″ long documents per thermal transfer ribbon and package of check stock. Printers 24A, 24B have an integrated cutter that will cut all but a small portion of the document, facilitating easy presentation and tear-off as checks are printed and ejected through respective slots 34. Each printer 24A, 24B is connected to the PC 14 via an RS232 serial port and prints checks in response to information received from the employer and based on the preference of the customer, as described hereafter. A pair of duplicate check printers are provided to double the total number of checks that can be printed and permit one printer to malfunction without completing disabling the system. Kiosk 12 further includes one 3-4″ wide direct thermal printer 30 for receipt printing. Receipt printer 30 is to the PC 14 via the USB or parallel printer port.

Computer 14 may be, for example, a Windows-compatible PC with the equivalent performance of a 500 MHz Celeron processor with 128 MB of RAM. Computer 14 supports at least two USB ports, 4 RS232 serial ports, one 56K modem, one parallel printer port and one 10/100 Ethernet port. Kiosk 12 may also include a UIC model MSR140 3 Track magnetic stripe card reader 16, or its equivalent. This device will be connected via RS232 serial port.

Capture pad 18 may be a Topaz Systems Signature Gem model T-S261-K signature capture pad. This device will be mounted at a convenient angle and height above the floor for use by a typical customer. The pad 18 is connected to the PC via the RS232 serial port. The LCD touch screen 26 is preferably a 15.1″ diagonal LCD panel with integrated capacitive or SAW technology. Touch screen 26 will connect to the PC 14 via a VGA connector for the video and USB port for the touch screen input. In the alternative, a separate display screen and keypad for entry of information can be provided as currently done on ATM machines.

The cash dispensers 28A, 28B, preferably Fujitsu F400's, will connect to the PC via two RS232 serial ports. The video camera 22 is preferably one that supports 16.7 million colors at 640×480 pixel resolution, has at least 1.3 million pixel resolution, and can capture 30 fps video at 352×288 pixel resolution. It connects to the PC 14 via a USB port. 12 MM mild steel is used to construct the cash dispenser vault in the lower section; sheet metal and plastic are used to fabricate the remainder of cabinet 12.

Cash dispensing mechanism 19 is provided with several cash cassettes (not shown) for dispensing funds in the form of currency into external slots 28 opening on the front face of cabinet 13. In a preferred embodiment, sufficient cassettes are provided to enable kiosk 12 to dispense currency in at least three, preferably four, denominations, for example one, five, ten and twenty dollar bills, or one, five, twenty and either fifty or one hundred dollar bills, the latter to enable the machine to dispense substantially larger amounts of money than an ATM can before requiring replenishment of currency. Kiosk 12 is also provided with a communications link 32 enabling computer 14 to communicate electronically over a network such as the Internet via SSL or over a private network such as a wide area network (WAN).

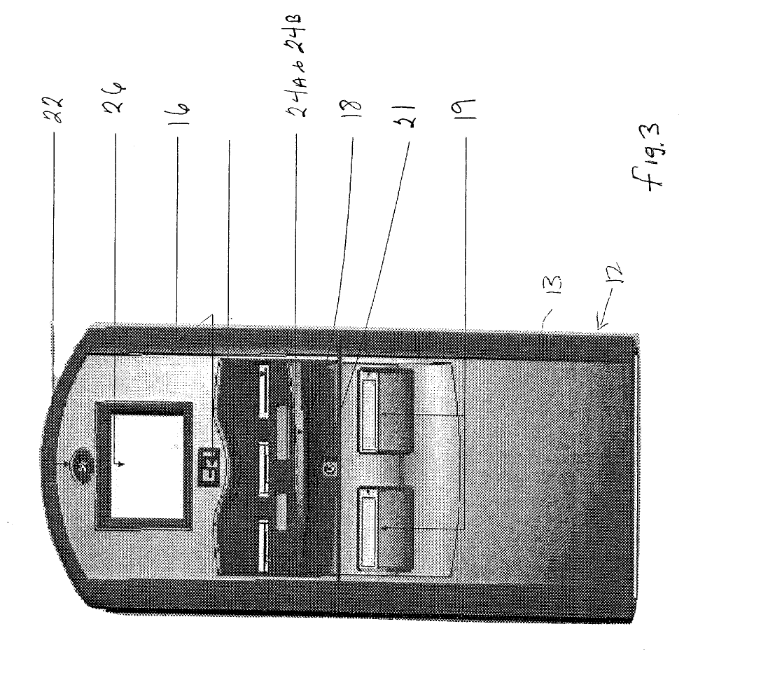

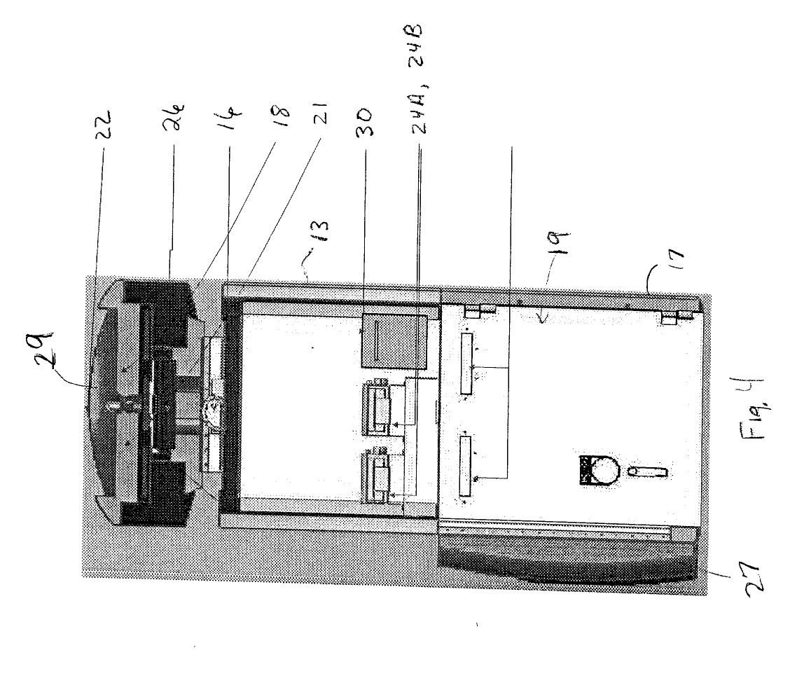

FIGS. 3 and 4 illustrate an alternative embodiment of a kiosk 12′ of the invention which can also be used as an ATM machine, which has the same components as kiosk 12 except as described otherwise. A numeric keypad 21 is present next to the capture pad 18 so that the machine can also be used as a conventional ATM. Kiosk 12′ has a lower door 27 and an upwardly opening hinged hatch 29 to aid in accessing the interior components of the machine. Camera 22, touch screen monitor 26 and card reader 16 are conveniently mounted on the underside of hatch 29 as shown.

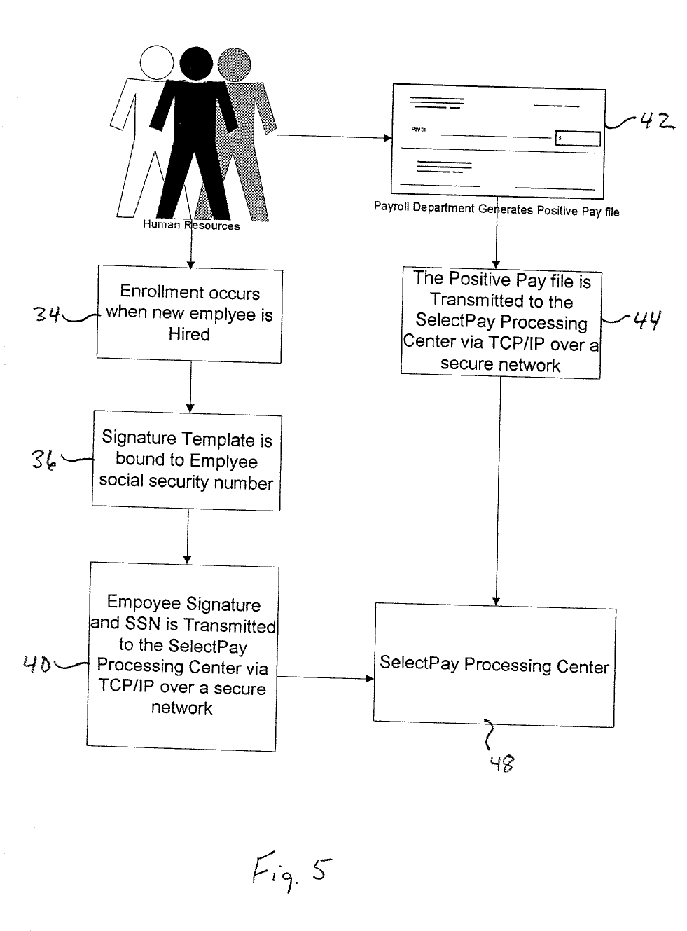

Turning to FIG. 5, a method of the invention is illustrated as a series of transactions beginning when an employer hires a new employee (step 34). The new employee is enrolled in a payroll system according to the invention, and an image of his or her signature is acquired, linked to the employee's social security number or other employee identification code (step 36) and transmitted to a central processing center through a secure communications link (step 40). If magnetic identification cards are to be used, the employee is issued such a card. The payroll processing center may be owned and operated by an entity separate from the employer.

When the employee is paid, the employer's payroll or accounting department generates or updates a pay file (step 42) including the unique employee identification number such as the employee's social security number and the amount of funds due the employee. The pay file or record is electronically transmitted (step 44) via a secure communications link to the processing center 48. In conjunction with the transfer of the pay file or files, the employer deposits funds in an account maintained by the service provider corresponding to the funds identified in the pay file. The service provider preferably performs the same functions as current commercial payroll services, namely calculation and withholding of taxes, retirement plan contributions, insurance premiums and other typical payroll deductions.

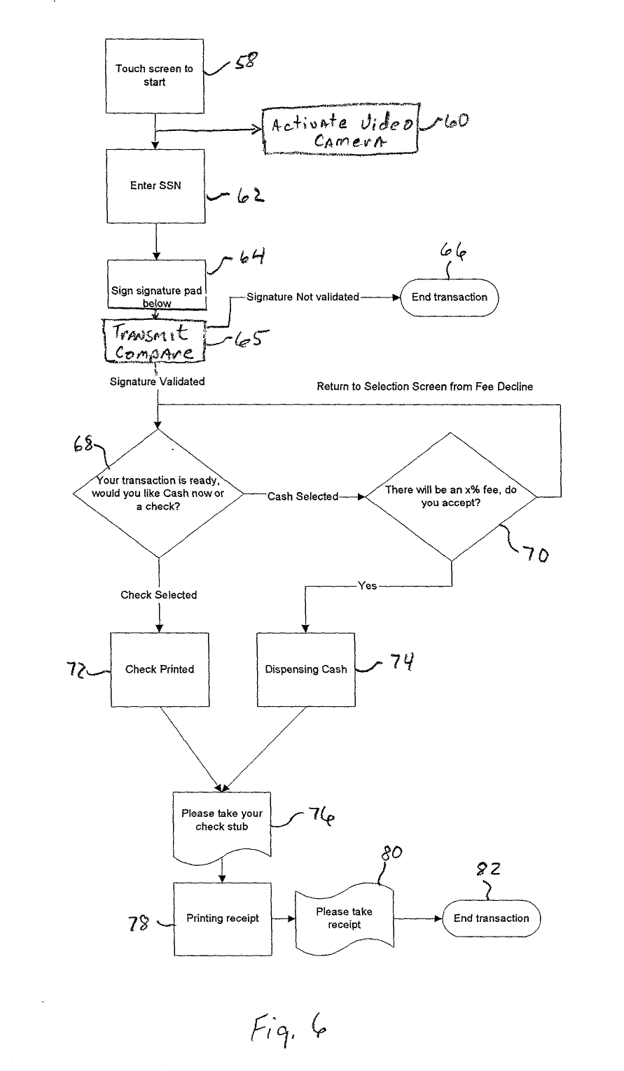

As best illustrated in FIG. 6, the employee utilizes kiosk 12 to access and receive the funds by pressing touch screen 26 to begin the process (step 58). Computer 14 then prompts the user to enter his or her employee identification number using touch screen 26 and signing on signature capture pad 18 (steps 62, 64). The employee may also be asked one or more multiple choice challenge response question as further confirmation, or in place of the signature capture process. For example, the employee maybe asked to select his or her mother's maiden name from a menu of choices, one of which is the correct name based on information the employee provided at the time of enrollment. Video camera 22 is activated (step 60) to create a still or motion video image of the employee. Optionally, computer 14 may be programmed not to dispense cash or print a check if video camera 22 is non-functional or blocked (returning a blank image).

Computer 14 then transmits the employee's identification number and the captured image of the employee's signature through the network to processing center, where the employee' identification number is used to access the record copy of the employee's signature (step 65). The captured image of the employee's signature appears on the touch screen and is compared to the record image maintained by a processing center using known image processing technology and software. If the processing center is unable to verily that the captured image is the employee's signature, it transmits a signal to kiosk 12 denying or refusing the transaction, and kiosk 12 is reinitialized (step 66). Successful reading of a magnetically encoded ID card using card reader 16 may also be required, in addition to or in place of signature verification. The card reader could also be used to read ATM or debit cards to permit other types of transactions to be carried out at kiosk 12, for example, cash withdrawals from bank accounts.

If the employee's signature and/or answer to the challenge response question(s) is verified, the central processing center transmits a signal to kiosk 12 approving the transaction and indicating the funds due to the employee according to the pay file stored at the processing center. Computer 14 then signals touch screen 26 to display a message prompting the customer to indicate whether cash or a check is desired (step 68). The employee then selects a cash disbursement or a check. If a cash disbursement is selected, the touch screen displays a message informing the employee that there will be a fee associated with the transaction, and querying whether the employee agrees to the fee (step 70). If the employee indicates agreement to the fee by pressing the indicated location on touch screen 26, computer 14 signals cash dispenser 28 to dispense cash to the employee (step 74). Alternatively, if the employee elects to receive funds in the form of a check, computer 14, utilizing the information in the pay file, signals check printer 26 to print a check payable to the employee (step 72).

Of course, payroll amounts will generally be expressed in dollars and cents, and kiosk 12 may lack the capability to generate cash in the exact amount due. The fee for selecting cash therefore conveniently includes any leftover amount of less than one dollar (or other currency). For example, a payment in the amount of $506.25 if cash were selected would have a 3% cash fee of $15.19 associated with it. The difference is $491.06. The fee is then increased slightly (by the amount of change due, from 1 to 99 cents) to $15.25 so that the amount of cash dispensed is $491.

Computer 12 can also be programmed to allow the consumer to enter a cash amount that is less than the total payroll payment due. Kiosk 12 then dispenses cash in the amount the employee has selected, together with a check for the difference between the total and the cash dispensed. In such a case, the fee for selecting cash does not include the additional amount less than one dollar or other currency unit.

Kiosk 12 can also be equipped with an optional cash card dispenser, in addition to or in place of the check printer. Cash cards are currently used as a form of temporary debit card with a limited value that can be discarded once used up. According to this aspect of the invention, if the user selects cash card, then a card is encoded and issued which can be used up to the amount of the payment due the user. A stored value card could be issued in a similar manner.

After the employee receives either cash or a check, kiosk 12 using the information in the pay file prints a non-negotiable payroll voucher (check stub) with a summary of the employee's payroll information including items such as gross pay, federal and state income taxes withheld, other deduction, fees assessed and similar items (step 76). After the employee has received the voucher, kiosk 12 prints a receipt (step 78) indicating the amount of funds disbursed and the form of the disbursement, i.e., cash, check or both. The employee is prompted to take the receipt (step 80) and the transaction is concluded (step 82). A record of the transaction is transmitted to processing center 48 (FIG. 5) which updates the employee's pay file 42 accordingly and may optionally transmit a report back to the employer-payor of payments made.

A kiosk 12 of the invention may conveniently be located on the premises of a large company with many employees and might not, in some cases, be located in an area open to the general public. Other services that make payments to customers can also use the method and machine of the invention, such as tax preparation services that generate advance refund checks to their customers, or even government agencies such as the IRS, SSA or welfare agencies that make recurring payments to citizens.

The method and system of the invention provide a convenient way to make recurring payments to employees or the like without forcing them to go to a bank or other outlet in order to cash a check or get cash from a debit card. Debit cards can be used at ATM's, but the amount of cash available will be subject to the ATM's transaction limit. The system of the invention may be programmed with an upper limit on the amount of cash that can be dispensed in a single transaction, but the limit will be higher than the typical ATM limit of $400 per account per day, and the kiosk will preferably hold sufficient cash to meet typical demand at the location the kiosk is deployed. In the alternative, if the amount to be paid is above the machines cash per transaction limit, the user is so advised in a message on the screen, and advised either that a check must be generated, or that the user can receive up to the limit in cash and the balance as a check. Insofar as the system of the invention is intended for making payments and does not maintain ongoing accounts for depositors in the manner of a bank or credit union, the user/payee is not normally allowed the option of taking less than all of the amount to be paid.

Although one or more embodiments of the invention have been described in the foregoing detailed description and illustrated in the accompanying drawings, it will be understood by those skilled in the art that the invention is not limited to the embodiments disclosed but is capable of numerous rearrangements, substitutions and modifications without departing from the spirit of the invention.

1. A method for making a payment, comprising:
(a) determining a payment amount due from a payor to a payee;
(b) identifying the payee when the payee enters identifying information at an automated payment station;
(c) verifying an amount of a payment due to the payee;
(d) receiving at the payment station an election by the payee to receive a check or cash as the payment;
(e) if the payee selected a check, printing a check for the payee at the payment station; and
(f) if the payee selected cash, dispensing cash to the payee at the payment station.

2. The method of claim 1, wherein the payor is an employer, the payee is an employee, and the payment due is employee wages.

3. The method of claim 1, further comprising the steps of:
enrolling a payee to receive payment by designating identifying information to the payee for use in step (b);
receiving an electronic pay file from the payor at a payment processing center remote from the payment station, including information identifying the payee and an amount due to be paid to the payee; and
step (c) then comprises transmitting information concerning the payee from the payment station to the processing center, and receiving back a verification of an amount due the payee from the processing center.

4. The method of claim 3, wherein the payor is an employer, the payee is an employee, the payment due is employee wages, and the pay file is a payroll file including payments due to a plurality of employees for a pay period.

5. The method of claim 1, further comprising assessing a fee if the payee elects to receive cash.

6. The method of claim 5, wherein the fee is calculated to include any amount less than the smallest unit of currency the payment station is able to dispense.

7. The method of claim 1, wherein step (b) comprises entering an identification code using an input device on the payment station.

8. The method of claim 7, wherein step (b) further comprises entering a signature using a signature capture device pad at the payment station and comparing the signature with a sample previously created by the payee.

9. The method of claim 7, wherein step (b) further comprises reading a magnetically encoded identification card issued to the payee using a card reader at the payment station.

10. An automated payment station, comprising:
a computer programmed to dispense cash and print checks according to program logic;
a check printer which prints checks in response to signals from the computer;
a cash dispenser which dispenses cash in response to signals from the computer;
a display device connected to the computer and positioned to display messages to a user;
a data entry device which permits entry of data and selection of options by the user; and
a cabinet enclosing the computer, check printer, cash dispenser, display device and data entry device, which cabinet has suitable access openings therein to permit the machine to 10 dispense cash and checks from the cash dispenser and check printer, respectively.

11. The station of claim 10, further comprising a signature capture pad mounted on the outside of the cabinet and connected to transmit an image of a signature to the computer.

12. The station of claim 10, further comprising a magnetic card reader accessible through a slot in the cabinet and connected to the computer to verify the identity of the cardholder.

13. The station of claim 10, wherein the program logic offers a user a choice of receiving a check or cash and actuates the check printer or cash dispenser in response to an election made by the user with the data entry device.

14. The station of claim 10, wherein the data entry device comprises tactile input elements of a touch screen, and the display device comprises a video display of the touch screen.

15. The station of claim 10, further comprising means for connecting the computer for electronic communication with a remote processing center which verifies the user's identity in response to queries sent by the computer and transmits to the computer a payment amount due to the user.

16. The station of claim 10, wherein the cash dispenser includes at least four cassettes contain currency in different denominations, at least one cassette containing a lowest common denominator currency.
